(19) United States
(12) Patent Application Publication
(10) Pub. No.: US 2007/0184680 A1
(43) Pub. Date: Aug. 9, 2007

(54) Socket board and test board system having the same

(75) Inventors: Duk-soon Choi, Asan-si (KR); Sung-woo Lee, Cheonan-si (KR); Taek-joon Jeon, Cheonan-si (KR); In-suel Hwang, Cheonan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/700,906

(22) Filed: Feb. 1, 2007

(30) Foreign Application Priority Data
Feb. 4, 2006 (KR) 10-2006-0010916

(51) Int. Cl. H01R 12/00

(52) U.S. Cl. 439/66

(57) ABSTRACT

A socket board may include an upper board supporting at least one test socket. The upper board may have a major surface defining a first reference plane. At least one stem board may support a stem board application circuit. The stem board may have a major surface defining a second reference plane that may intersect the first reference plane. A conductive member may connect the test socket to the stem board application circuit.

### PRIORITY STATEMENT

This application claims the benefit of Korean Patent Application No. 10-2006-0010916, filed on Feb. 4, 2006, in the Korean Intellectual Property Office, the disclosure of which is incorporated herein in its entirety by reference.

### BACKGROUND

1. Field

Example embodiments relate to a test apparatus for a semiconductor integrated circuit (IC) device, and more particularly, to a socket board for testing a system-on-chip and a test board system implementing the socket board.

2. Description of the Related Art

A system-on-chip (SoC) is a semiconductor device that may incorporate a plurality of intellectual property (IP) cores, which may be functional blocks each having a specific function, into a single chip. The SoC, which may integrate a plurality of functions into one chip, may be provided having a miniaturized size, light weight, improved processing speed, improved product reliability, and/or lower costs. However, it may be time-consuming to test the variety of functions of the SoC and thus the time-to-market and/or the test cost may increase.

The SoCs may be tested in parallel using parallel test boards. The parallel test board may have two through eight device-under-test (DUT) sockets to simultaneously test a plurality of SoCs.

FIG. 1 is a perspective view of a conventional parallel test board for testing a plurality of SoCs.

Referring to FIG. 1, a parallel test board 50 may include a main board 10 and, for example, eight DUT sockets 20 may be mounted on the main board 10. An SoC 5 may be mounted on each DUT socket 20. A plurality of application circuits 30 may be arranged on the peripheral area of the DUT sockets 20 to test the corresponding SoCs 5. An area 30a occupied by the application circuits 30 may be 30-50% (for example) of an area 20a occupied by a DUT socket group 21. If the parallel test board 50 has a 2×4 arrangement of DUT sockets 20 (as shown), then the peripheral area around the DUT socket group 21 may be sufficient to accommodate the area 30a for the application circuits 30. However, if the parallel test board has a 2×8 or 4×8 arrangement of DUT sockets 20, then the peripheral area around the DUT socket group may not be sufficient to accommodate the area 30a for the application circuits.

As the number of DUT sockets 20 increases, the size of the main board 10 may also be increased to provide a sufficient peripheral area around the DUT socket groups 21 to accommodate the application circuits 30. In order not to increase the size of the main board 10, the application circuits 30 may be arranged between the DUT sockets 20. In a SoC test process, several SoCs may be picked up by a handler of an automated chip transfer machine and inserted in the respective DUT sockets 20 arranged on the main board 10 simultaneously. During such handling, the SoCs 5 may be fixed by, for example, a plurality of tweezers and/or suction portions that may be placed on the handler. When the test is finished, the handler may sort the SoCs 5 and insert the same into a semiconductor chip transferring/storing unit such as a tray, for example.

On the one hand, if the size of the main board is increased due to an increase in the number of DUT sockets, then the moving distance of the handler may increase and thus the test time may increase. This also may increase the test cost. On the other hand, if the application circuits are arranged between the DUT sockets, then a distance between the DUT sockets (during handling) may increase and thus it may be necessary to modify and/or replace peripheral equipments, such as the handler, for example. Furthermore, if the DUT sockets and/or the application circuits malfunction, then the parallel test board system may be replaced. This may increase maintenance costs.

### SUMMARY

Example embodiments of a socket board may (for example) reduce the time required for testing an SoC by (for example) increasing the number of DUT sockets without increasing the size of a parallel test board and/or the distance between the DUT sockets.

Example embodiments may provide a socket board that may reduce maintenance costs and/or the time required for testing an SoC.

According to example, non-limiting embodiments, a socket board may include an upper board supporting at least one test socket. The upper board may have a major surface defining a first reference plane. At least one stem board may support a stem board application circuit. The stem board may have a major surface defining a second reference plane that intersects the first reference plane. The first and the second reference planes may intersect at right angles. A conductive member may electrically connect the test socket to the stem board application circuit. The upper board may have a rectangular shape, and the stem board may be divided into four stem board sections.

A semiconductor chip package selected from the group consisting of a TSOP (Thin Small Outline Package), a BGAP (Ball Grid Array Package), a DIP (Dual Inline Package), a QFP (Quad Flat Package), and a CSP (Chip Scale Package) may be inserted into the test socket. A distance between the test sockets may be determined by a distance between pickup portions of a chip transfer machine.

The socket board may include a upper board application circuit arranged on the upper board and electrically connected to the test socket. The upper board application circuit may include an element arranged adjacent to the test socket. The stem board application circuit may test at least one of a direct current, alternate margin, timing generation, and functions of a semiconductor chip package inserted into the test socket.

The conductive member may be a flexible printed circuit board. In addition, the socket board may include a frame block supporting the upper board and the stem board. The frame block may be a hexahedron. The socket board may include coupling units for fixing the upper board and the stem board to the frame block. The frame block may be fabricated from a material that may prevent an electromagnetic interference. Alternatively (or in addition), the frame block may include a recess that may accommodate the stem board application circuit.

According to example, non-limiting embodiments, a test board system may include a socket board. An interface board may have a slot into which the socket board may be inserted. A base board may be connected to the interface board. A spacer may be interposed between the interface board and the base board.

One of the interface board and the base board may include a common application circuit. The common application circuit may include at least one of a variable power supply unit, a control unit for controlling application circuits, and an analog and/or digital channel control unit.

The interface board and the base board may be interconnected by a plurality of signal cables. The signal cable may be a high frequency connector or a coaxial cable. The spacer may include a shock absorbing unit having a margin in a vertical direction. The test board system may include a housing having an opening that may expose the socket board.

According to example, non-limiting embodiments, a method of fabricating a socket board may involve providing an upper board supporting at least one test socket. The upper board may have a major surface defining a first reference plane. At least one stem board may be provided supporting a stem board application circuit that may be electrically connected to the test socket. The stem board may have a major surface defining a second reference plane. The upper board and the stem board may be oriented so that first and the second reference planes intersect each other.

### BRIEF DESCRIPTION OF THE DRAWINGS

Example, non-limiting embodiments will be described with reference to the attached drawings.

FIG. 1 is a perspective view of a conventional parallel test board for testing a SoC.

FIGS. 2a and 2b are perspective views of a socket board according to an example embodiment.

FIG. 3 is a perspective view of a frame block according to an example embodiment.

FIG. 4 is a perspective view of a parallel test board system according to an example embodiment.

FIG. 5 is a perspective view of a housed parallel test board system according to an example embodiment.

### DESCRIPTION OF EXAMPLE NON-LIMITING EMBODIMENTS

Example embodiments will be described with reference to the accompanying drawings. Example embodiments may, however, be embodied in many different forms and should not be construed as being limited to example embodiments set forth herein; rather, example embodiments are provided so that this disclosure will be thorough and complete, and will fully convey the teachings herein to those skilled in the art. In the drawings, the thickness and/or size of each element may be exaggerated for clarity. The drawings are not to scale. Like reference numerals in the drawings denote like elements, and thus their description may be omitted.

It will be understood that when a component is referred to as being “on,” “connected to” or “coupled to” another component, it can be directly on, connected to or coupled to the other component or intervening components may be present. In coritrast, when a component is referred to as being “directly on,” “directly connected to” or “directly coupled to” another component, there are no intervening components present. As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used for ease of description to describe one component or feature's relationship to another component(s) or feature(s) as illustrated in the drawings. It will be understood that the spatially relative terms are intended to encompass different orientations of the device in use or operation in addition to the orientation depicted in the figures.

The terminology used herein is for the purpose of describing example embodiments only and is not intended to be limiting. As used herein, the singular forms “a,” “an” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, and/or components.

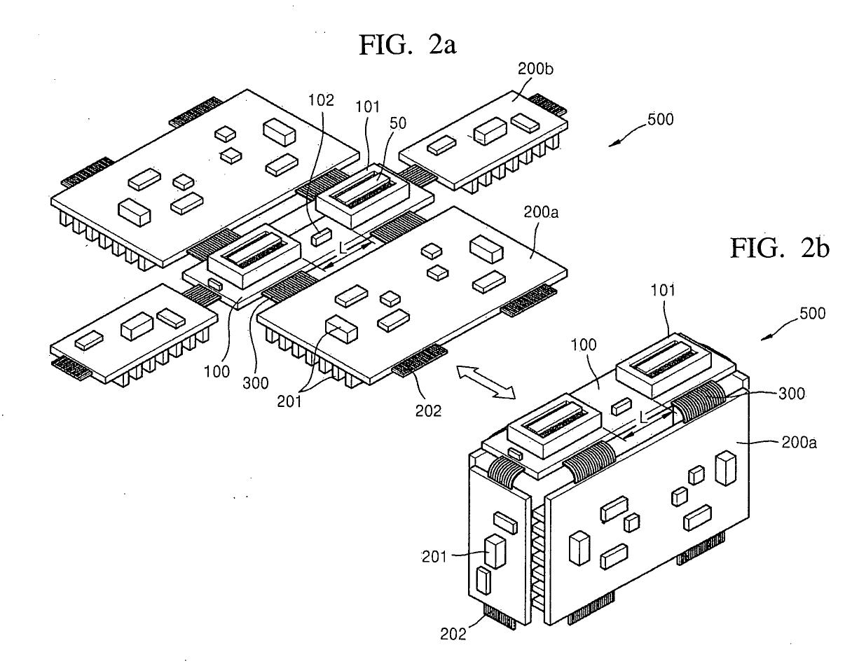

FIGS. 2a and 2b are perspective views of a socket board 500 according to an example embodiment.

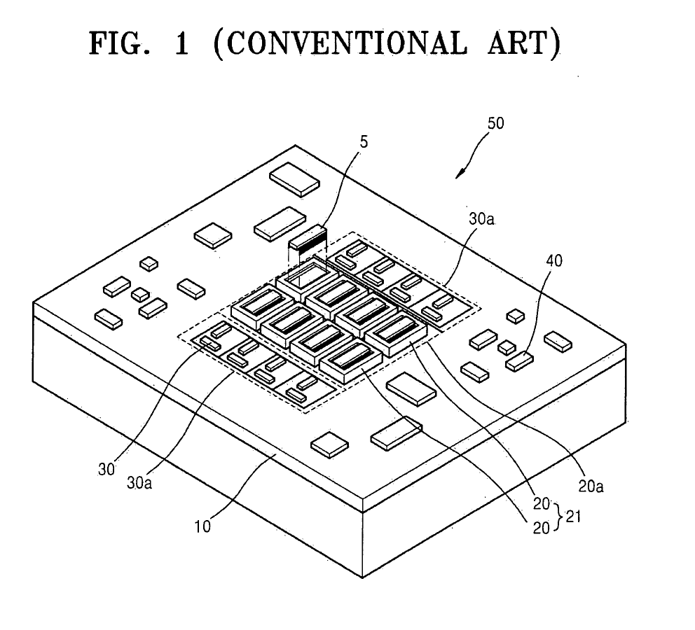

As shown, the socket board 500 may include an upper board 100 supporting one or more DUT sockets 101, a stem board 200a, 200b, and a plurality of conductors 300 extending between the upper board 200 and the stem board 200a, 200b. By way of example only, the conductors 300 may be flexible parallel conductors. However, numerous and varied conductors (which are well known in this art) may be suitably implemented. By way of example only, the upper board 100 may have a rectangular shape and the stem board 200a, 200b may be divided into four stem board sections. In alternative embodiments, the upper board 100 may have some other geometric shape (other than a rectangle), and the stem board may include more or less than four stem board sections. The socket board 500 may be inserted into a slot (not shown) formed on the main board 10 depicted in FIG. 1.

The DUT sockets 101 may be designed to receive SoCs 50 formed in a variety of packages. For example, in FIG. 2, the DUT sockets 101 may be designed to receive thin small outline packages (TSOP). In alternative embodiments, the DUT sockets 101 may be designed to receive ball grid array packages (BGAG), dual inline packages (DIP), quad flat packages (QFP), and/or chip scale packages (CSP), for example. A distance L between the DUT sockets 101 may be determined by a specification of a handler (not shown) of an automated chip transfer machine, e.g., a distance between pickup portions such as tweezers and/or suction portions of the handler.

A first application circuit 102 for testing the SoCs 50 may be placed on the upper board 100. By way of example only, the first application circuit 102 may be a passive element such as a resistor, inductor and/or condenser that may be disposed adjacent to the DUT sockets 101. The first application circuit 102 may improve (for example) the testing reliability for the SoCs 50.

A major surface of the upper board 100 may define a first reference plane. And a major surface of the stem board 200a, 200b may define a second reference plane. The upper board 100 and the stem board 200a, 200b may be oriented so that the first and the second reference planes intersect each other. For example, as shown in FIG. 2b, the stem board 200a, 200b may be disposed at right angles to the upper board 100. In alternative embodiments, the stem board 200a, 200b may be disposed at an incline relative to the upper board 100. Second application circuits 201 for testing the SoCs 50 may be placed on a top and/or a bottom surface of the stem boards 200a and 200b. The second application circuits 201 may function to perform a variety of tests, such as a direct current test, alternate margin test, timing generation test, and/or functional test (for example) for IP cores that are functional blocks. For example, when the SoC 50 includes a memory module and/or a wireless communication module, the second application circuits 201 may include a memory module test circuit and/or a radio frequency (RF) generating/receiving circuit. The stem boards 200a and 200b may support additional circuits, which may have a relatively large volume-element (such as a relay, switch, buffer, and/or power, for example). According to example embodiments, the second application circuits 201 may be placed on the stem board 200a, 200b disposed on a side surface of the socket board 500. Accordingly, there may be no need to provide the area (30a of FIG. 1) for accommodating the second application circuits on the main board (10 of FIG. 1) of the parallel test board (50 of FIG. 1). Instead, the area for accommodating the second application circuits may be provided by the stem board 200a, 200b.

The socket board 500 according to example embodiments may provide a sufficient area for accommodating the first and the second application circuits 102 and 201, and this may be done without any area restriction of the parallel test board (50 of FIG. 1). Even if the number of DUT sockets is increased, there may be no need to increase the size of the parallel test board (50 in FIG. 1) and/or the distance L between the DUT sockets 101. Because there may be no need to provide the area 30a for accommodating the second application circuits on the parallel test board (50 of FIG. 1), the size of the test board may be reduced. As a result, the socket board 500 according to example embodiments may improve the test process efficiency by (for example) reducing the moving distance of the handler of the automated chip transfer machine and/or increasing the number of SoCs that may be tested in parallel.

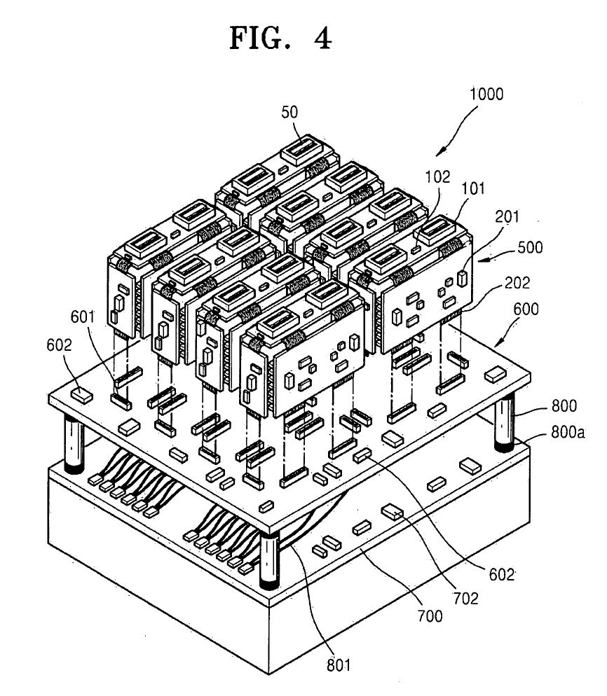

Conductive pads 202 may be placed on the stem board 200a, 200b. Turning briefly to FIG. 4, the conductive pads 202 may be inserted into slots 601 of a parallel test board 600. In this way, the parallel test board 600 may support and be electrically connected to the socket board 500. The socket board 500 may be easily coupled to and/or separated from the parallel test board 600. As a result, if the socket board 500 becomes out of order (for example), it may be easily replaced. This may reduce maintenance costs.

The socket board 500 may include a plurality of conductors 300 that may electrically connect the upper board 100 to the stem board 200a, 200b. The conductors 300 may be flexible to facilitate arranging the upper board 100 and the stem board 200a, 200b in a desired orientation with respect to each other (e.g., at right angles). Compare FIGS. 2a and 2b. The conductors 300 may be flexible printed circuit boards, which are well known in the art.

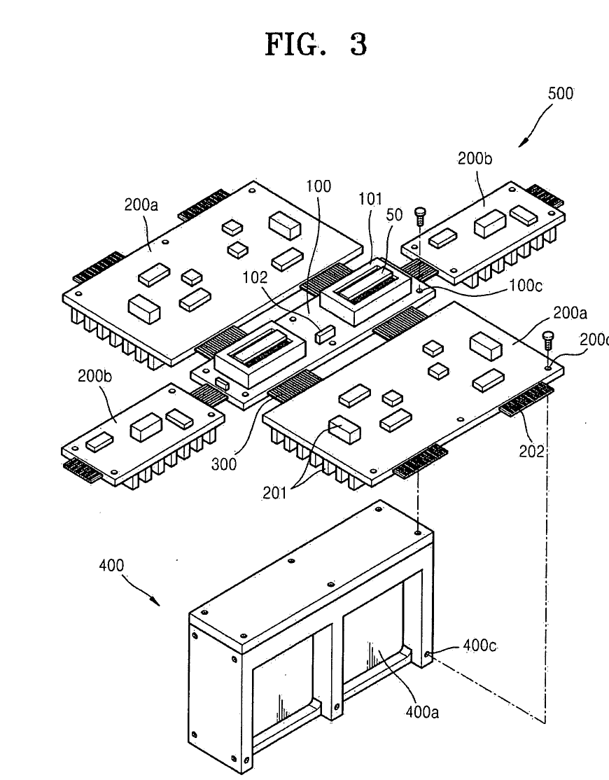

FIG. 3 is a perspective view of a frame block 400 according to an example embodiment.

Referring to FIG. 3, the socket board 500 may include a frame block 400 that may support the stem boards 200a and 200b as well as the upper board 100. Coupling portions 100c, 200c and 400c may be respectively formed on the upper board 100, the stem boards 200a and 200b and the frame block 400. By way of example only, the coupling portions 100c, 200c and 400c may in the form of holes. In this way, the upper board 100 and the stem boards 200a and 200b may be coupled to the frame block 400 by bolts inserted into the holes.

In the socket board 500, the DUT sockets 101 and first application circuit 102 (which may be placed on the upper board 100) and the second application circuits 201 (which may be placed on the stem boards 200a and 200b) may be arranged closer to each other as compared with the conventional art test board. Accordingly, there may be electromagnetic interference between the first application circuit 102 and the second application circuits 201 and/or between the first and the second application circuits 102 and 201 and the SoCs 50 inserted into the DUT sockets 101. Therefore, the frame block 400 may be fabricated from a material such as a metallic material and/or ceramic material (for example) that may screen the electromagnetic interference. Alternatively (or in addition), the form block 400 may include a recess 400a for screening the electromagnetic interference. The recess 400a may receive the second application circuits 201. By forming the frame block 400 using a material for screening the electromagnetic interference and/or forming the recess 400a in the frame block 400, test errors that may be caused by the electromagnetic interference may be prevented.

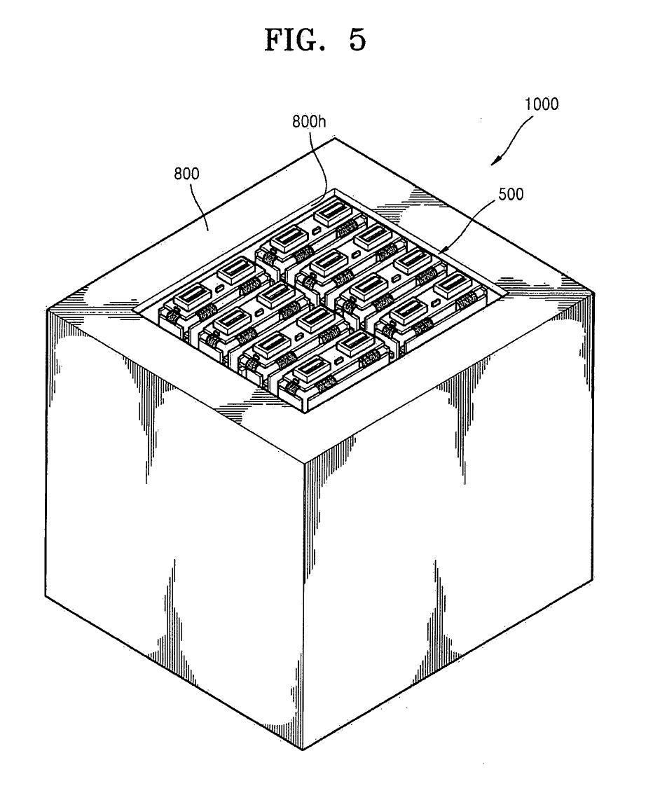

FIG. 4 is a perspective view of a parallel test board system 1000 according to an example embodiment. FIG. 5 is a perspective view of a housed parallel test board system illustrated in FIG. 4.

Referring to FIG. 4, a parallel test board system 1000 may include a plurality of the socket boards 500 illustrated in FIG. 2. The parallel test board system 1000 may include an interface board 600 (or parallel test board), a base board 700, and a plurality of spacers 800 that may maintain a space between the interface board 600 and the base board 700.

A plurality of board slots 601 (which may receive the conductive pads 202 of the socket boards 500) may be arranged on the interface board 600. The conductive pads 202 of the socket boards 500 may be electrically connected to and physically supported by the board slots 601. The socket boards 500 may be easily coupled to and/or separated from the interface board 600. As a result, if the socket board 500 becomes out of order (for example), it may be easily replaced. That is, there may be no need to replace the overall body of the interface board 600 (or parallel test board). This may reduce maintenance costs.

Because the first and the second application circuits 102 and 201 may be arranged on the socket board 500, application circuits arranged on the interface board 600 and the base board 700 may be simplified. In addition, sizes of the interface board 600 and the base board 700 may be reduced as compared with the conventional art test board (50 of FIG. 1). Application circuits 602 and 702 may be placed on the interface board 600 and the base board 700. These application circuits 602 and 702 may be common application circuits that may be generally applied to IC chip tests. By way of example only, the common application circuit may include a variable direct and/or alternate power supply unit for receiving electric power from an external source and generating a variety of voltages, a control unit for controlling the first and the second application circuits 101 and 201, an analog and/or digital channel control unit for a parallel test, and/or a signal output unit for transmitting result signals to an outer test device.

According to example embodiments, the parallel test board system 1000 may be universal to the extent that numerous and varied types of SoCs 50 may be tested by replacing the socket boards 500. That is, there may be no need to replace the interface board 600 and/or the base board 700. Furthermore, because the first and the second application circuits 102 and 201 may be arranged on the socket board 500, the number of DUT sockets 101 arranged on the interface board 600 may be increased. As a result, the number of SoCs 50 that may be tested per hour may be increased, thereby increasing the test process efficiency.

The interface board 600 and the base board 700 may be interconnected by a plurality of signal cables 801. The signal cables 801 may be high frequency cables and/or coaxial cables, for example. As a result, a cross talk phenomenon caused by electromagnetic interference may be reduced in the transmission and/or reception of the test signals.

The interface board 600 may be spaced apart from the base board 700 by the spacers 800. The spacer 800 may include a shock absorption unit 800a such as a Hi Fix board, for example. Because the interface board 600 and the base board 700 may be spaced apart from each other, impacts generated when the SoCs 50 are being mounted on and/or removed from the DUT sockets 101 may be absorbed. This may improve the endurance of the parallel test board system 1000. The parallel test board system 1000 may include a housing 800, as shown in FIG. 5, for protecting the interface board 600 and the base board 700. The housing 800 may be provided with an opening 800h that may expose an area of the interface board 600 on which the socket boards 500 may be placed.

Example embodiments may be implemented to test SoCs. In alternative embodiments, the socket board and the parallel test board including the socket board may be applied to test alternative IC chips (other than SoCs). Example embodiments may be implemented to test IC chips in parallel and/or in consecutive order.

According to example embodiments, the socket board may include the stem boards on which the application circuits may be placed. Accordingly, there may be no need to provide an area for accommodating the application circuits on the main board of the parallel test board. As a result, the number of DUT sockets may be increased without necessarily having to increase the distance between the DUT sockets and/or the size of the parallel test board. This may improve the test efficiency.

By virtue of the parallel test board system implementing the socket board according to example embodiments, the size of the parallel test board and/or the distance between the DUT sockets may be reduced, thereby improving the test efficiency. Because the common application circuits may be placed on the interface board and the base board, the manufacturing and maintenance cost and/or time for the parallel test board system may be reduced.

Example, non-limiting embodiments have been particularly shown and described. It will be understood by those of ordinary skill in the art that various changes in form and details may be made therein, and that such changes are intended to fall within the spirit and scope of the following claims.

What is claimed is:

1. A socket board, comprising:
an upper board supporting at least one test socket, the upper board having a major surface defining a first reference plane;
at least one stem board supporting a stem board application circuit, the stem board having a major surface defining a second reference plane that intersects the first reference plane; and
a conductive member electrically connecting the test socket to the stem board application circuit.

2. The socket board of claim 1, wherein the upper board has a rectangular shape and the stem board is divided into four stem board sections.

3. The socket board of claim 1, wherein a semiconductor chip package selected from the group consisting of a TSOP (Thin Small Outline Package), a BGAP (Ball Grid Array Package), a DIP (Dual Inline Package), a QFP (Quad Flat Package), and a CSP (Chip Scale Package) is inserted into the test socket.

4. The socket board of claim 1, further comprising a plurality of the test sockets, wherein a distance between the test sockets is determined by a distance between pickup portions of a chip transfer machine.

5. The socket board of claim 1, further comprising an upper board application circuit arranged on the upper board and electrically connected to the test socket.

6. The socket board of claim 5, wherein the upper board application circuit includes an element arranged adjacent to the test socket.

7. The socket board of claim 1, wherein the stem board application circuit tests at least one of a direct current, alternate margin, timing generation, and functions of a semiconductor chip package inserted into the test socket.

8. The socket board of claim 1, wherein the conductive member is a flexible printed circuit board.

9. The socket board of claim 1, further comprising a frame block supporting the upper board and the stem board.

10. The socket board of claim 9, wherein the frame block is a hexahedron.

11. The socket board of claim 9, further comprising coupling units to fix the upper board and the stem board to the frame block.

12. The socket board of claim 9, wherein the frame block is fabricated from a material preventing an electromagnetic interference.

13. The socket board of claim 9, wherein the frame block includes an area preventing an electromagnetic interference.

14. A test board system comprising:
the socket board of claim 1;
an interface board having a slot into which the socket board is inserted;
a base board connected to the interface board; and
a spacer interposed between the interface board and the base board.

15. The test board system of claim 14, wherein one of the interface board and the base board supports a common application circuit.

16. The test board system of claim 15, wherein the common application circuit includes at least one of a variable power supply unit, a control unit for controlling application circuits, and an analog and/or digital channel control unit.

17. The test board system of claim 14, wherein the interface board and the base board are interconnected by a plurality of signal cables.

18. The test board system of claim 17, wherein the signal cables are high frequency connectors or coaxial cables.

19. The test board system of claim 14, wherein the spacer includes a shock absorbing unit having a margin in a vertical direction.

20. The test board system of claim 14, further comprising a housing having an opening exposing the socket board.

21. The test board system of claim 14, wherein the interface board supports more than eight socket boards, and each socket board includes two test sockets.

22. The socket board of claim 1, wherein the first and the second reference planes intersect at a right angle.

23. The socket board of claim 1, wherein the conductive member is flexible.

24. A method of fabricating a socket board, comprising:
providing an upper board supporting at least one test socket, the upper board having a major surface defining a first reference plane;
providing at least one stem board supporting a stem board application circuit that is electrically connected to the test socket, the stem board having a major surface defining a second reference plane; and
orienting the upper board and the stem board so that first and the second reference planes intersect each other.
